(19) United States
(12) Patent Application Publication
(10) Pub. No.: US 2018/0214720 A1
(43) Pub. Date: Aug. 2, 2018

(54) Protective Garment With Functional Window

(71) Applicants: Patrick GOOI, Calgary (CA); Adrian GOOI, Winnipeg (CA); Kevin WARRIAN, Calgary (CA)

(72) Inventors: Patrick GOOI, Calgary (CA); Adrian GOOI, Winnipeg (CA); Kevin WARRIAN, Calgary (CA)

(21) Appl. No.: 15/747,700

(22) PCT Filed: Jul. 27, 2016
(86) PCT No.: PCT/CA2016/050878

§ 371 Date: Jan. 25, 2018

Related U.S. Application Data
(60) Provisional application No. 62/197,942, filed on Jul. 28, 2015.

(51) Int. Cl. A62B 17/00

(52) U.S. Cl. CPC A62B 17/006

(57) ABSTRACT

A hazardous materials protective garment for protecting the wearer while maintaining the sterile field, and further offering the wearer the ability to directly access and interface with technological equipment being operated during a surgical procedure. The hazardous materials protective garment comprising one or more functional windows positioned on the garment to allow the wearer to interface with a device attached to the wearer underneath the garment, for example a device attached to the wearer's arm and/or chest. The windows disposed in the garment are sized and adapted to accommodate a variety of devices including cameras for POV filming and/or recording, as well as control displays for remotely located technological equipment.

### FIELD OF THE INVENTION

The present invention relates to the field of protective garments such as a hazardous materials suit and, in particular, to protective garments having one or more functional windows configured to allow the wearer to access and control accessory equipment within the protective suit.

### BACKGROUND OF THE INVENTION

Hazardous materials suits (hereinafter referred to as a hazmat suit) is an overall garment worn to protect people from hazardous materials or substances, including chemicals, biological agents, fire/high temperatures, and/or radioactive materials. Hazmat suits are typically designed for a specific application and generally fall into the categories of splash protection and gastight suits. The hazmat suit may protect against chemical agents using an appropriate barrier such as Teflon, heavy polyvinyl chloride (PVC), rubber, or flashspun high-density polyethylene fibers. For protection from nuclear agents, the suit may additionally have radiation shielding in the lining and a respiration system to prevent direct contact with or inhalation of radioactive particles or gas. A hazmat suit protecting against biological agents are fully sealed systems under pressure to prevent contamination even if the suit is damaged or using powered air purifying respirators. Various classification systems exist in various countries and military applications as is known in the art.

One such classification is the U.S. Occupational Safety and Health Standards 1910.120 App B, herein incorporated by reference in its entirety. This regime classifies protective garments as either Level A, B, C, or D based on the degree of protection they provide. A Level A suit protects against vapors, gases, mists, and particles by incorporating a self-contained breathing apparatus (SCBA) or a supplied air respirator (SAR) with an escape cylinder. To qualify as Level A protection, an intrinsically safe two-way radio is worn inside the suit. A Level B garment provides protection against splashes from hazardous chemicals but is not vapor-protective. The Level B suit also has a SCBA breathing apparatus but may be worn on the outside of the garment. Depending on the type of chemical being handled, additional gloves and boots may be donned and may or may not be attached to the garment. A Level C garment is the same type of garment used for Level B protection but allows for the use of respiratory protection equipment other than SCBA which includes various types of air-purifying respirators. Level C does not offer protection needed in an oxygen displaced atmosphere. A Level D garment does not protect against chemical exposure and can only be used in situations where there is no possibility of contact with chemicals. Most firefighting gear is considered to be Level D. Europe has a similar system ranging from Type 1 to Type 6 with Type 1 being gas tight protection against liquid and gaseous chemicals and Type 6 protecting only parts of the body against liquid chemicals.

One such hazmat garment is disclosed in U.S. Pat. No. 5,948,708 to Langley, herein incorporated by reference. The garment comprises a multi-layer composite consisting of a chemical barrier layer, a flame resistant layer, and a reflective layer. The chemical barrier layer is itself a composite material having multiple substrates selected to minimize permeability.

As personal computing devices such as mobile phones, tablets, portable cameras, etc. use increases, hazmat personnel find it necessary to retrieve information from these devices. This is usually impossible as that would require a potentially long decontamination, and in many cases discarding the hazmat garment. In some instances, the hazmat personnel may use the device while in the hazmat garment resulting in contamination of the device.

A surgical gown with a functional window is disclosed in Canadian Patent Publication No. 2,851,845 to Gooi, the entire content herein incorporated by reference. The surgical gown protects the wearer while maintaining the sterile field, and further offering the wearer the ability to directly access and interface with technological equipment being operated during a surgical procedure. The surgical gown comprising one or more functional windows positioned on the gown to allow the wearer to interface in a sterile manner with a device attached to the wearer underneath the gown, for example a device attached to the wearer's arm and/or chest. The intention of the surgical gown is generally to protect the patient from contamination rather than protect the wearer of the garment from hazardous substances in the environment. In most cases, a surgical gown comprises a barrier that would not be sufficient to protect a user under hazmat conditions. Therefore, an improved system and method for interacting with computing devices is necessary for a hazmat suit.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present disclosure is to provide a hazardous materials protective garment with one or more functional windows configured to allow the wearer to access and control accessory equipment under hazardous conditions. In accordance with one aspect, there is described a hazardous materials protective garment for protecting a wearer, comprising one or more flexible and transparent windows disposed in the garment to allow the wearer to directly interface through the one or more windows with a device attached to the wearer underneath the garment.

In accordance with another aspect, there is described a hazardous materials protective garment for protecting a wearer from a hazardous environment, the hazardous materials protective garment comprising a pair of sleeves and one or more flexible and transparent windows disposed in one or both sleeves of the garment, whereby the wearer can conveniently thereby view the device and directly interface with the device through the one or more windows, the device being attached to the arm of the wearer underneath the garment.

In accordance with a further aspect, there is described a hazardous materials protective garment for protecting a wearer from a hazardous environment, the hazardous materials protective garment comprising a front body portion and a flexible and transparent window centrally disposed on the front body portion of the garment, the window sized to accommodate a camera attached to the wearer's chest, wherein the wearer can directly interface with the camera to film or record a procedure through the window centrally disposed on the front body portion of the garment.

According to embodiments of the present disclosure, the hazardous materials protective garment comprises one or more functional windows positioned on the garment to allow the wearer to interface with a device attached to the wearer underneath the garment. The hazardous materials protective garment according to embodiments of the present disclosure provides the dual function of protecting the wearer from a hazardous environment, and further offers the wearer the ability to directly access and interface with technological equipment being operated. According to embodiments of the present disclosure, the hazardous materials protective garment comprises one or more functional windows positioned on the garment to allow the wearer to interface with a device attached to the wearer underneath the garment. The functional window(s) is located on the garment to allow the wearer to easily view and actuate operation of the device, for example, by directly depressing control buttons or a touchscreen display, through the functional window(s). In this regard, the functional window(s) is positioned on the garment in locations that allow convenient and comfortable access by the wearer. For example, according to certain embodiments, the functional window(s) is located on the sleeve of the garment to allow the wearer direct access and/or control of a device that is attached to the wearer's arm directly underneath the functional window(s). In other embodiments, the functional window(s) is located on the front body of the garment to allow the wearer direct access and/or control of a device that is attached to the wearer's chest directly underneath the functional window(s). In further embodiments, the hazardous materials protective garment comprises multiple functional windows that can include one or more functional window(s) located on one or each sleeve and/or a functional window located on the front body of the garment. In this way, the wearer has access to multiple devices and/or control systems.

According to embodiments of the present disclosure, the functional window is transparent to allow clear visibility of the device and/or controls positioned underneath. The functional window is further flexible to allow tactile interfacing by the wearer thereby offering the wearer direct control over the connected device. According to certain embodiments, the functional window is made of a pliable or flexible material to allow the operation of physical buttons by the wearer. In other embodiments, the functional window comprises an electrically conductive layer coupled to the wearer to permit operation of a capacitive touchscreen display.

According to a further embodiment, the functional window is adapted to house a filming or recording device, such as a camera. In such embodiments, the functional window may be centrally located on the body of the garment approximately in the chest area of the wearer to allow the wearer to directly operate a camera attached to the wearer's chest underneath the functional window. In addition to being more comfortable for the wearer, chest-mounting of a camera provides greater stability resulting in less movement of the camera and a better quality recording. According to such embodiments, the functional window can be further adapted to be outwardly extendable in order to accommodate a variety of camera and lens positions. For example, the lens may be extendable to zoom in and out from the wearer's chest. In other embodiments, the camera may be mounted on an extendable mount attached to the wearer's chest.

### BRIEF DESCRIPTION OF THE DRAWINGS

These and other features of the invention will become more apparent in the following detailed description in which reference is made to the appended drawings.

FIG. 1 is a front elevational view of a hazmat garment with functional windows disposed in each sleeve of the garment, according to embodiments of the present disclosure;

FIG. 2 is cross section view of the layers of the hazmat suit; and

FIG. 3 is cross section view of the layers of a window of the hazmat suit.

### DETAILED DESCRIPTION OF THE INVENTION

Unless defined otherwise, all technical and scientific terms used herein have the same meaning as commonly understood by one of ordinary skill in the art to which this invention belongs. As used herein, the term “disposable” describes articles that are not intended to be restored or reused and which are intended to be discarded after a single use. As used herein, the term “about” refers to an approximately +/−10% variation from a given value. It is to be understood that such a variation is always included in any given value provided herein, whether or not it is specifically referred to.

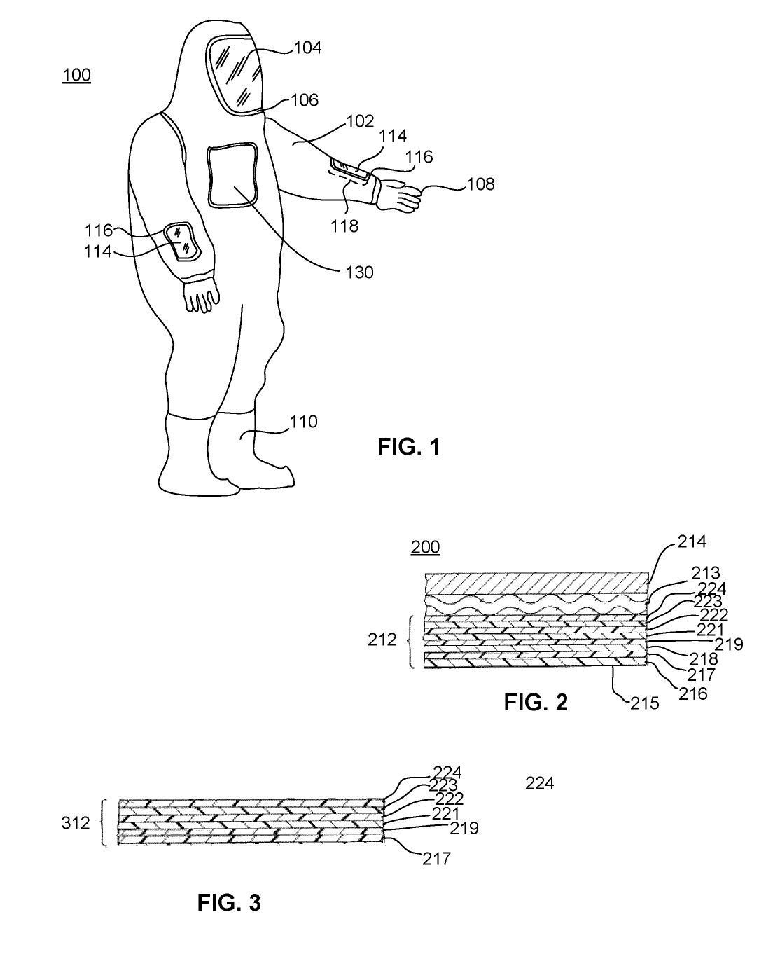

FIG. 1 demonstrates a hazmat suit 100 of the present disclosure. The hazmat suit 100 comprises a series of protective layers 200, shown further with reference to FIG. 2 below. The hazmat suit 100 shown is of the Level A variety, however, the inventor contemplates that the concepts described herein may apply equally well to other types of hazmat suits. The hazmat suit 100 has a pair of arms 102 that protect the user's arms and also comprises a pair of gloves 108. A pair of boots 110 also protects the user's feet and typically comprises steel toe boots. A transparent visor 104 protects the face of the user while permitting the user to view through the visor 104. The visor 104 has an interface 106 with the protective layers 200 to permit the visor material 104 to be different than the material of the suit 100. The visor 104 may comprise a more expensive and/or less durable material that is transparent to enable vision therethrough whereas the remainder of the suit 100 may comprise less expensive or more protective materials.

Turning now to FIG. 2, the protective material 200 comprises three functional layers of material which are bonded together to form a composite fabric. Layer 212 comprises a chemical barrier layer that affords protection against a wide variety of chemicals. Layer 213 is flame resistant layer of material which blocks flame impingement on the thermoplastic inner layer 212. Layer 214 is a reflectant aluminized layer covering the flame resistant layer 213 to create a reflective surface on the exterior side. Alternatively, the layer 214 may be a reflective layer of a material such as metallized polyethylene terephthalate. In either event, layer 214 is designed to prevent radiant energy from reaching layers 212 and 213 when exposed to a chemical flash fire. Such protection may ensure that the thermoplastic inner layer 212 does not collapse or melt onto the wearer, thus, the wearer would be able to escape the area before any further thermal loading might occur.

As noted above, metallized polyethylene terephthalate may be used as layer 214. Polyethylene terephthalate has heat resistance to 300° F. and is classified as a slow burning to self-extinguishing plastic according to ASTM standards. It may be bonded to layer 213 which may be a woven fiberglass layer that provides an economical fire retardant layer. Other materials suitable for use in this layer are carbonized fibers (pre-ox), flame-retardant rayon, flame-retardant cotton, flame-retardant wool, high density polyethylene and aramid fibers.

Chemical barrier 212 is ideally a multi-chemical barrier that may be a co-extruded multi-stratum composite having a layer of linear low density polyethylene 215 adjacent a layer of nylon 216 adjacent a layer of ethylene vinyl alcohol 217, adjacent a layer of nylon 218, adjacent a layer of polyethylene 219, adjacent a layer of chlorinated polyethylene 221, adjacent a layer of ethylene vinyl acetate 222, adjacent a layer of polyvinylidene chloride 223, adjacent a layer of ethylene vinyl acetate 224. Additionally, layers of teflon, nylon, polypropylene, acrylonitrile, metallized thin films, and polyvinylidene chloride copolymers may be substituted or added as desired. The chemical barrier layer 212 and the metallized fabric of layers 213 and 214 may be bonded together by applying heat and pressure, for example up to 300° F. at 40 psi, to bond the chemical barrier layer to the flame-resistant impingement layer to form the composite fabric. The bonding may be accomplished due to a polymer layer of the chemical barrier which is heat sealable being positioned adjacent the fiberglass layer, and the material then being concomitantly passed through a heated roller.

The hazmat suit 100 may comprise windows 114 disposed anywhere in the suit 100 to allow the wearer to comfortably view and interface with the mobile device. For example, the windows 114 may be disposed in the sleeves 102 and/or anywhere in the front portion of the suit 100 such as the left or right side of the chest area or centrally located. The one or more windows 114 are transparent enabling the user to view the displays of electronic devices (not shown) placed below. Similar to the visor 114, the windows 114 have interfaces 116 coupling the windows 114 to the protective layers 200 of the suit 100. Beneath the windows are compartments 118 in the suit sized to fit the desired mobile device (not shown). The compartments 118 are typically made of a compliant material that enables the user to squeeze the mobile device into the compartment 118 preventing the mobile device from moving out of the compartment 118 during use of the hazmat suit 100. The compliant material may also become sealed during use in order to isolate the mobile device from the user in case of breach of the window with the external hazardous atmosphere. Optionally, any type of releasable fasteners may be used, including mechanical and chemical fasteners such as mechanical straps, snaps, ties, and/or adhesives. In particular embodiments the releasable fasteners include conventional hook and loop fasteners such as Velcro™ fasteners of Velcro Industries B.V. to secure the mobile device.

The windows 114 comprise a similar chemical barrier 312 as for the protector layers 200 of the rest of the suit 100. In order to properly view the display of the mobile device, the non-transparent layers are removed. The chemical barrier 312 may comprise a co-extruded multi-stratum composite of a layer of linear low density polyethylene 315 adjacent a layer of ethylene vinyl alcohol 317, adjacent a layer of polyethylene 319, adjacent a layer of chlorinated polyethylene 321, adjacent a layer of ethylene vinyl acetate 322, adjacent a layer of polyvinylidene chloride 323, adjacent a layer of ethylene vinyl acetate 324. Since nylon is only a translucent material, the nylon layers are removed from the window 114. Alternatively, in order to maintain some strength in the window 114, nylon threads may be present in a grid or cross-hatched pattern over the window 114 in a density low enough for the user to be able to still read and interact with the display. Additional layers of transparent material may also be provided in the window area that reflect infrared radiation but permit transmission of visible light therethrough.

Layer 315 is electrically conductive and is in contact with the skin of the user and thus exhibits a similar capacitance of the user's finger. When the user presses on the outer layer of ethelene vinyl acetate 324 using their glove 108, this causes all the layers 312 to compress and the conductive polyethelene layer 315 contacts the surface of the touch screen of the mobile device. The contact point is registered as the touch point on the capacitive touch screen.

The interface 116 between the window 114 and the suit 102 may comprise an interwoven nylon thread assembly in order to provide increased strength and protection around the window 114. The interface 116 comprises a seal that meets or exceeds the barrier performance standards required to maintain the appropriate level of hazmat protection. For example, a suitable seal may be provided by heat fusion, ultrasonic welding, chemical adhesives, and/or combinations thereof, depending on the particular materials used for the hazmat suit 100 and the windows 114.

It should be appreciated that the type of fabric or material used for hazmat suit 100 is not a limiting factor of the invention. Moreover, although it is contemplated that the hazmat suit 100 shown and described herein may be disposable, in particular embodiments, the hazmat suit 100 may be decontaminated and re-used.

Although specific layers have been described above, the windows 114 may be fabricated from any one or more materials, which are substantially transparent, flexible, and capable of meeting the barrier performance standards required to protect the user from a hazardous environment. Examples of potentially suitable materials include polymeric (plastic) materials, e.g., thermoplastic or thermosetting polymers of high molecular weight and that can be made into sheets. In further embodiments, the windows 114 may comprise polymers such as polyethylene (PE), polyvinylchloride (PVC), polypropylene (PP), and combinations or mixtures thereof.

As mentioned above, in certain embodiments, the windows 114 may be fabricated from a material that is capable of being decontaminated by decontamination techniques commonly used in industrial facilities known in the art.

The dimensions of the windows are dependent on the type of mobile device is intended to be used with the hazmat suit 100. As demonstrated above, the one or more windows 114 are disposed in the sleeves 102 and the windows 114 are sized to allow an unobstructed view by the wearer of a mobile device that optionally be attached to the arm of the wearer underneath. According to embodiments of the present disclosure, one or both sleeves 102 may comprise one or more windows 114 of varying sizes to accommodate a range of devices. In certain embodiments, the device is the technological equipment itself sized such that it can be attached to the arm of the wearer. In other embodiments, the device is a control display for technological equipment that is remotely located, the control display being sized for attachment to the arm of the wearer. In this way, the wearer can directly control the remotely located equipment, for example, without contaminating the controls or the remotely located equipment. In such embodiments, the controls are positioned directly underneath the one or more windows disposed in the sleeve. The controls can comprise buttons that can be physically actuated by the wearer through the windows 114 which are transparent and flexible to allow tactile control therethrough. Alternatively, the controls can comprise a touchscreen display that is responsive to the wearer through the window 114.

According to the embodiment shown in FIG. 1, the size of the window 114 can vary up to the size allowed by the sleeve 102. The inventor contemplates that the entire sleeve 102 or a substantial portion of the sleeve 102 can form the window 114. The dimensions of the window 114, according to embodiments, can range in size to provide a viewing area ranging from about 5 cm to about 30 cm in length, and about 5 cm to about 15 cm in width. In other embodiments, the window 114 is sized to provide a viewing area ranging from about 10 cm to about 20 cm in length, and about 7 cm to about 10 cm in width. In further embodiments, the window 114 is sized to provide a viewing area ranging from about 15 cm to about 30 cm in length, and about 10 cm to about 15 cm in width.

Moreover, while in the embodiments shown, window 114 is generally rectangular, the inventor contemplates that the window 114 may be of substantially any convenient size and shape, including circular, oval, trapezoidal, and/or other polygonal or ovoid shapes, etc., suitable for enabling a wearer to view and directly interface with a device attached to the wearer's arm underneath the hazmat suit 100 and beneath the window 114. Still further, the window 114 may be a single window 114, as shown disposed in each sleeve 102, or by a series of smaller windows 114 disposed in spaced relation to one another, without departing from the scope of the present invention.

The inventor contemplates that windows 114 similar to the embodiments shown in FIG. 1, can be disposed in the front body portion 130 of the hazmat suit 100 to allow the wearer to access and interface with a device attached to the wearer's chest for example. Such embodiments would be appropriate to access devices which may require a larger viewing area than what is available through a window 114 disposed in the sleeve 102. Such embodiments may also permit other users wearing such suits 100 to interface with the display on the other user's chest. According to such embodiments, the windows 114 may be sized to provide a viewing area 130 that can vary up to the size allowed by the frontal body portion. For example, the dimensions of the window 130, according to such embodiments, can range in size to provide a viewing area ranging from about 5 cm to about 40 cm in length, and about 5 cm to about 35 cm in width. In other embodiments, the window 130 is sized to provide a viewing area ranging from about 10 cm to about 30 cm in length, and about 15 cm to about 25 cm in width. In further embodiments, the window 130 is sized to provide a viewing area ranging from about 15 cm to about 25 cm in length, and about 15 cm to about 25 cm in width.

The inventor further contemplates that hazmat suit 100 may comprise any combination of windows disposed in the sleeves 102 and/or the frontal body portion 130 of the suit 100. Alternatively, in instances of high heat, it may be preferable to place the window 130 on the back of the suit 100 to reduce the amount of heat on the frontal body portion from reaching the device and/or the user of the suit while the user is facing the heat source.

In an alternative, the windows 114 or 130 may be adapted to accommodate specialized technological equipment such as a camera to allow the wearer to photograph, film and/or record procedures from the wearer's point of view (POV). In such embodiments, the camera may be centrally disposed in the front window 130. In addition to being more comfortable for the wearer, chest-mounting of the camera provides greater stability resulting in less movement of the camera and a better quality recording. In instances where camera equipment must look through the windows 114 or 130, the window 114 or 130 is constructed of materials having an ultra-clear optical quality to avoid compromising the quality of the photos, filming and/or recording taken through the window 114 or 130. A variety of known optically clear materials are known in the art and can include polymeric (plastic) materials, e.g., thermoplastic or thermosetting polymers. In further embodiments, the windows 114, 130 comprise polymers such as polyethylene (PE), polyvinylchloride (PVC), polypropylene (PP), and combinations or mixtures thereof. One such commercially known material includes LenzfleX™.

According to further embodiments, the window 130 may be further adapted to be outwardly extendable to varying distances away from the wearer's chest in order to accommodate a variety of camera and lens positions. For example, the lens may be extendable to zoom in and out from the wearer's chest. In other embodiments, the camera may be mounted on an extendable mount attached to the wearer's chest underneath the hazmat suit 100. A further description of such a feature is presented in Canadian Publication No. 2,851,845, herein incorporated by reference.

It is contemplated that any embodiment discussed herein can be implemented with respect to any method or composition of the invention, and vice versa. Furthermore, compositions and kits of the invention can be used to achieve methods of the invention.

The disclosures of all patents, patent applications, publications and database entries referenced in this specification are hereby specifically incorporated by reference in their entirety to the same extent as if each such individual patent, patent application, publication and database entry were specifically and individually indicated to be incorporated by reference.

The scope of the claims should not be limited by the preferred embodiments set forth in the foregoing examples, but should be given the broadest interpretation consistent with the description as a whole, and the claims are not to be limited to the preferred or exemplified embodiments of the invention.

1. A hazardous materials protective garment for protecting a wearer from a hazardous environment, comprising:
at least two protective layers bonded together to form a composite fabric;
at least one flexible and transparent windows disposed within the composite fabric; the at least one window comprising one or more layers of transparent protective material to allow the wearer to directly interface through the at least one window with a display underneath the at least one window.

2. The hazardous materials protective garment according to claim 1, wherein the hazardous materials protective garment comprises a pair of sleeves and the at least one window is disposed in one or both sleeves.

3. The hazardous materials protective garment according to claim 2, further comprising at least one compartment for holding the display in a position beneath the at least one window.

4. The hazardous materials protective garment according to claim 3, wherein the at least one compartment is sealed from the user during use.

5. The hazardous materials protective garment according to claim 1, wherein the display is a touch screen actuated by the wearer through the one or more windows.

6. The hazardous materials protective garment according to claim 5, wherein an inner layer of transparent protective material is electrically conductive and in contact with the wearer.

7. The hazardous materials protective garment according to claim 6, wherein contact with an exterior layer of transparent protective material compresses the inner layer to contact the touch screen.

8. The hazardous materials protective garment according to claim 1, wherein the at least two protective layers are selected from at least one of a chemical barrier layer; a flame resistant layer; and a reflectant layer.

9. The hazardous materials protective garment according to claim 8, wherein the flame resistant layer comprises a woven fiberglass.

10. The hazardous materials protective garment according to claim 8, wherein the reflectant layer comprises an aluminized layer or a metalized polyethylene terephthalate.

11. The hazardous materials protective garment according to claim 8, wherein the chemical barrier layer comprises at least one of: a layer of polyethylene, a layer of nylon, a layer of ethylene vinyl alcohol, a layer of polyethylene, a layer of chlorinated polyethylene, a layer of ethylene vinyl acetate, and a layer of polyvinylidene chloride.

12. The hazardous materials protective garment according to claim 11, wherein the chemical barrier layer further comprises at least one of a layer of Teflon, a layer of polypropylene, a layer of acrylonitrile, a layer of metalized thin films, and polyvinylidene chloride copolymers.

13. The hazardous materials protective garment according to claim 1, wherein the one or more layers of transparent protective material comprise at least one of a layer of linear low density polyethylene, a layer of ethylene vinyl alcohol, a layer of polyethylene, a layer of chlorinated polyethylene, a layer of ethylene vinyl acetate, a layer of polypropylene, a layer of polyvinylchloride, and a layer of polyvinylidene chloride.

14. The hazardous materials protective garment according to claim 13, wherein the transparent protective material further comprises nylon strands.

15. The hazardous materials protective garment according to claim 13, wherein the transparent protective material further comprises a layer of infrared reflective material that permits passage of visible light.

16. The hazardous materials protective garment according to claim 6, wherein the inner layer of transparent protective material is conductive polyethelene.

17. The hazardous materials protective garment according to claim 1, wherein the at least one window is sealed to the at least two protective layers using at least one of heat fusion, ultrasonic welding, chemical adhesives, and/or combinations thereof.

18. The hazardous materials protective garment according to claim 1, wherein the hazardous materials protective garment comprises a front body portion and a window centrally disposed on the front body portion of the garment to allow the wearer to directly interface through the window centrally disposed on the front body portion of the garment with a device attached to the wearer's chest underneath the garment.

19. The hazardous materials protective garment according to claim 18, wherein the window is sized to accommodate a camera attached to the wearer's chest.

20. The hazardous materials protective garment according to claim 19, wherein the window comprises an optically-clear material to allow a clear view through the window for filming and/or recording therethrough.
